(19) United States
(12) Patent Application Publication
(10) Pub. No.: US 2026/0045752 A1
(43) Pub. Date: Feb. 12, 2026

(54) TERMINATION AND CUTTING TOOL FOR A PLURALITY OF 4 DIFFERENT RJ JACK CONFIGURATIONS

(71) Applicant: Surtec Industries Inc., Keelung City (TW)

(72) Inventor: Chou-Hsing CHEN, Keelung City (TW)

(21) Appl. No.: 18/796,621

(22) Filed: Aug. 7, 2024

(51) Int. Cl. H01R 43/28

(52) U.S. Cl. CPC H01R 43/28

(57) ABSTRACT

The wire termination and cutting tool (100, 100′, 100″, 100″′) is configured for RJ jacks in various orientations. The tool includes a tool base including a tool cutting module and RJ jack support portions. A handle applies force to move the cutting module with respect to the RJ jack support portion. A base slider is configured to move along a receiving surface between a first slider position and a second slider position. The base slider has a slider space for receiving an RJ jack having a first orientation and cooperates with the receiving surface to define a receiving surface space for receiving an RJ jack having a second orientation allowing a positioning of a respective RJ jack relative to the cutting module based on the base slider position. A slider fixing mechanism fixes the base slider in one or more of the first slider position and the second slider position.

### TECHNICAL FIELD

The present invention relates generally to termination tools used in computer networks and the telephone industry, specifically those configured for seating, terminating, and cutting the free ends of wires inserted into wire terminal receptacles connected to RJ-type jacks (communication modules).

### BACKGROUND

Existing RJ jack termination tools are often cumbersome and require multiple steps to achieve a proper termination. These tools may also need more precision for high-performance networking environments, leading to signal loss and unreliable connections.

Traditional RJ jack termination tools, such as those described in patents U.S. Pat. Nos. 7,444,744, 8,283,564, and 8,881,368, involve a process that can be time-consuming and prone to errors. These tools typically require the user to switch between different cutting module support portions and RJ jack support portions to accommodate various RJ-type jacks. This raises the complexity of the termination process while increasing the risk of misalignment and damage to the wires or the jacks. U.S. Pat. No. 7,444,744 describes a tool configured to terminate RJ jacks by aligning and cutting the wires inserted into the terminals. While it emphasizes the importance of precision in alignment to ensure proper termination, the tool requires multiple manual adjustments and steps to accommodate different types of RJ jacks. This can be time-consuming and increase the likelihood of errors. Similarly, U.S. Pat. No. 8,283,564 focuses on a wire insertion and cutting mechanism that ensures the wires are properly seated in the RJ jack terminals. However, this device requires switching between different modules or making manual adjustments to accommodate various RJ-type jacks, which can be cumbersome and prone to user error.

U.S. Pat. No. 8,881,368 presents a tool that provides a method for terminating RJ jacks with a focus on maintaining alignment and proper wire cutting. However, the tool's design necessitates multiple steps and adjustments for different RJ-type jacks, complicating the termination process and potentially leading to misalignments and improper terminations. U.S. Pat. No. 10,439,352 incorporates mechanisms to improve the precision of wire terminations, ensuring that the wires are correctly aligned and seated within the RJ jack terminals. Despite its advanced features, the tool still suffers from ergonomic and usability issues. Its weight and the complexity of its adjustments can lead to user fatigue and inconsistent termination results over extended use. Similarly, US20060277746 aims to provide high-precision terminations by focusing on the alignment and cutting of wires within RJ jacks. However, the heavy and complex design of the tool makes it difficult to use for extended periods, potentially leading to user fatigue and errors. The need for multiple adjustments to fit different RJ-type jacks remains a significant drawback. US20090133250 describes a tool for terminating RJ jacks, emphasizing the importance of precision in wire alignment and cutting. The tool requires manual adjustments for different RJ-type jacks, increasing the complexity of the termination process and the potential for errors. US20090307901 outlines a tool configured for terminating RJ jacks, focusing on precision and alignment. The tool's design is either too specialized for a single type of RJ jack or too generalized, requiring multiple adjustments or components for different types, making it less user-friendly and efficient. US20100071202 focuses on providing a method for terminating RJ jacks with proper alignment and cutting of wires. The need for manual adjustments and multiple steps for different RJ-type jacks complicates the termination process, leading to potential misalignments and errors. US20120110837 emphasizes the importance of precision in wire alignment and cutting for terminating RJ jacks. Similar to other prior art, this tool requires multiple steps and adjustments for different RJ-type jacks, which can be cumbersome and prone to user error. In addition to the aforementioned patents, several other patents referenced in US8418346B2 and US8418347B2 further illustrate the evolution and limitations of existing RJ jack termination tools. This includes U.S. Pat. No. 5,195,230, which focuses on a tool for seating and cutting wires in an RJ jack but requires multiple components and adjustments for different jack types.

### SUMMARY

It is an object of the present invention to provide a wire termination and cutting tool that enables a plurality of orientations for RJ jacks.

It is an object of the present invention to provide a wire termination and cutting tool that allows for accurate, smooth, and easy movement of a cutting module relative to an RJ jack for seating and cutting wires efficiently. The tool easily terminates wires to wire terminals, such as the Insulation Displacement Contacts (IDCs) of an RJ-type jack. The tool integrates material and mechanical innovations to further enhance its usability, durability, and efficiency in terminating twisted pair cables for telecommunications and networking applications.

According to the invention, a wire termination and cutting tool is provided for RJ jacks having a plurality of orientations. The wire termination and cutting tool comprises a tool base comprising a tool cutting module support portion and an RJ jack support portion comprising a jack or slider receiving surface. A cutting module is connected to the cutting module support portion. The tool base is configured with the cutting module support portion for movement of the cutting module relative to the RJ jack support portion. A tool handle applies force to move the cutting module with respect to the RJ jack support portion. A base slider is configured to be positioned in contact with the receiving surface and is moveable along the receiving surface between a first slider position relative to the receiving surface and a second slider position or more positions relative to the receiving surface. The base slider defines a slider space for receiving an RJ jack having a first orientation and cooperates with the receiving surface to define a receiving surface space for receiving an RJ jack having a second orientation. The RJ jack having the first orientation is receivable in the base slider space to position the RJ jack having the first orientation relative to the cutting module with the base slider in the first slider position and the RJ jack having the second orientation is receivable in the receiving surface space to position the RJ jack having the second orientation relative to the cutting module with the base slider in the second slider position. A slider fixing mechanism is configured to fix the base slider in one or more of the first slider position and the second slider position.

The base slider may comprise a slider base portion with slider side walls extending therefrom. The base slider space is delimited by an inner surface of the base slider side walls and an upper surface of the base slider base portion. The receiving surface space is delimited by support portion side walls and a support portion base wall that define the receiving surface and by a front surface of the base slider, with the base slider in the second slider position. The base slider and the receiving surface may cooperate to form a slider guide to guide the movement of the base slider between the first slider position and the second slider position. The base slider and the receiving surface may cooperate to form a slider limit stop to limit the movement of the base slider beyond at least one of the first slider position and the second slider position.

The slider fixing mechanism may comprise fixing openings in the jack support portion, which fixing openings comprise a first fixing opening to establish the first slider position relative to the receiving surface and a second fixing opening to establish a second slider position relative to the receiving surface. A base slider fixing opening may be provided, wherein the base slider fixing opening is configured to be in registration with the first fixing opening, with the base slider in the first slider position relative to the receiving surface, and to be in registration with the second fixing opening, with the base slider in the second slider position relative to the receiving surface. A fixing member may be inserted in the first fixing opening and the base slider fixing opening to fix the base slider in the first slider position relative to the receiving surface and may be inserted in the second fixing opening and the base slider fixing opening to fix the base slider in the second slider position relative to the receiving surface. The fixing member may comprise a screw or a pin.

According to other embodiments, the slider fixing mechanism may comprise fixing portions in the jack support portion, which fixing portions comprise a first recess or hole to establish the first slider position relative to the receiving surface and a second recess or hole to establish a second slider position relative to the receiving surface. A fixing member may be associated with the base slider and resiliently supported at the base slider and biased towards an engagement position. With the fixing member in the engagement position, the fixing member is received in the first recess or hole to fix the base slider in the first slider position relative to the receiving surface and with the fixing member in the engagement position the fixing member is received in the second recess or hole to fix the base slider in the second slider position relative to the receiving surface. The fixing member may comprise: a fixing channel or bore; a fixing spring supported in the fixing channel or bore; and a positioning ball supported relative to the channel or bore and biased towards the engagement position. The positioning ball is engageable with the first recess or hole to fix the base slider in the first slider position relative to the receiving surface and the positioning ball is engageable with the second recess or hole to fix the base slider in the second slider position relative to the receiving surface. The fixing member may comprise: a protrusion support associated with the base slider; and a protrusion elastically supported by the protrusion support relative to the base slider and biased towards the engagement position. The protrusion is engageable with the first recess or hole to fix the base slider in the first slider position relative to the receiving surface and the protrusion is engageable with the second recess or hole to fix the base slider in the second slider position relative to the receiving surface. The protrusion support may comprise: spaced apart attachment portions attached to the base slider; and a bridging portion supporting the protrusion, the bridging portion extending between the spaced apart attachment portions to define an elastic contraction space to allow elastic flexing of the bridging portion to allow movement of the protrusion out of the first recess or hole and out of the second recess or hole.

The support portion side walls may advantageously form a wire release mechanism configured for wire release after a cutting of wires being cut and terminated with the cutting module.

The tool cutting module support portion and the tool base may be at least partially formed of polymer.

The wire termination and cutting tool may further comprise an alignment guide configured for precise wire placement to ensure accurate and consistent positioning during termination, comprising multiple channels or slots corresponding to required positions for proper wire termination, maintaining correct spacing and orientation upon wires being inserted.

The tool handle, connected to the tool cutting module support portion, may comprise an ergonomic shape configured to reduce user fatigue, comfortably fitting within the user's hand to reduce strain during extended use, with a contoured grip conforming to the natural curve of the hand for a secure hold. The contoured grip may be padded with soft, non-slip materials at contact points, distributing weight evenly to reduce operational effort, minimizing pressure points to prevent discomfort and fatigue, enabling prolonged use with reduced risk of repetitive strain injuries.

The RJ jacks may have a plurality of orientations and may comprise standard RJ jacks and high-density RJ jacks. The wire termination and cutting tool is compatible with both standard RJ jacks and high-density RJ jacks.

The wire termination and cutting tool may further comprise a cutting mechanism for trimming excess wire length following wire termination, with the cutting mechanism integrated into the tool and operable by squeezing the handle or engaging a lever, causing high-strength blades to sever the excess wire coordinated to the termination point, thereby ensuring termination.

The RJ jack termination tool according to the present invention addresses the noted issues by integrating multiple functionalities into a single, user-friendly device that ensures high-quality terminations.

The wire termination and cutting tool according to the present invention is configured to retain a wire termination receptacle in precise alignment with a wire insertion/cutting head, which is actuated by a trigger mechanism. This function ensures accurate engagement with the wire termination receptacle—to seat and cut one or more wires inserted into the respective wire termination receptacles. The advancement of this present invention eliminates the user's need to switch between different cutting module support portions and RJ jack support portions for various RJ-type jacks. Traditional tools either cater to a single RJ-type jack or require multiple components for cutting and jack support, resulting in increased setup time, complexity, and a higher risk of losing parts. The transition from metal to a high-strength polymer construction reduces production costs, enhances the tool's strength and durability, and offers an eco-friendly alternative. The cutting module support portion and the RJ jack support portion are configured to remain consistent throughout the product's lifecycle, incorporating a newly invented adjustable slider support mechanism. This mechanism allows the tool to seamlessly adapt to different RJ-type jacks without requiring additional components, thus simplifying the termination process. The improved design addresses the limitations of current market offerings by providing a versatile, cost-effective solution that is easier to use, transport, and maintain, significantly reducing the complexity of switching between multiple parts and offering a user-friendly experience. This innovation enhances operational efficiency, contributes to cost savings, and supports environmental sustainability, making it an ideal tool for modern telecommunications and networking needs.

The RJ jack termination tool according to the present invention integrates a consistent cutting module support portion with a newly configured RJ jack support portion that features an adjustable base slider mechanism. This base slider allows for seamless adaptation to different RJ-type jacks without the need for additional components. By providing this tool formed from a high-strength polymer construction, the tool achieves a significant reduction in weight while maintaining structural integrity and durability. The polymer material enhances user ergonomics and handling, making the termination process more efficient and less physically demanding. The tool not only simplifies the termination process but also ensures consistent, high-quality terminations across a range of RJ-type jacks. The tool addresses the shortcomings of existing tools by offering a versatile, cost-effective, and environmentally friendly solution, making it ideal for modern telecommunications and networking needs.

Furthermore, this invention simplifies the process of terminating different types of RJ jacks. In traditional tools, switching between different cutting module support portions and RJ jack support portions was necessary to accommodate various RJ-type jacks. This process was time-consuming and increased the risk of misalignment and errors during termination. The RJ jack termination tool according to the invention overcomes this limitation with a novel RJ jack support portion that includes a slider with a sliding track mechanical mechanism. This innovative mechanism allows for seamless adjustment to different (appearance design/dimension, for both 90/180 degree and other RJ jacks) RJ-type jacks without needing additional components or manual switching.

A significant advancement in this invention is the transition from metal alloy to a stronger polymer for constructing the wire termination tool. This change in material offers several benefits, including a substantial reduction in the tool's weight without compromising its structural integrity and durability. The use of high-strength polymer enhances user ergonomics by making the tool lighter and easier to handle during the termination process. The user-friendly and efficient design improvement addresses user fatigue issues associated with the prolonged use of heavier metal alloy tools.

The base slider with sliding track mechanism is incorporated with various designs, such as spring balls, plugs, or fixture mechanical configurations to hold different RJ-type jacks in place securely. This flexibility ensures that the wire insertion parts are aligned accurately with the insulation displacement contacts of the RJ jack, thereby ensuring high-quality terminations. The adjustable slider mechanism simplifies the termination process, reduces setup time, and minimizes the potential for errors, resulting in more consistent and reliable connections.

It is a further object of the invention to provide a simple and dependable wire termination tool in which the cutting/seating head is a cutting module that can be easily replaced, for example with a screwdriver or another simple tool. This ensures that maintenance and partial replacement are straightforward, minimizing downtime and enhancing the tool's longevity.

The cutting module includes wire insertion parts that are spring-mounted, ensuring that the cutting blades cut the wires after they are seated into position within the insulation displacement contacts of the RJ jack. This ensures precise and clean cuts, which are critical for maintaining the integrity of the network connections.

The RJ jack support portion features an adjustable base slider with a sliding track mechanism, enabling an RJ jack to be positioned in multiple ways for seating (terminating) and cutting wires. This versatility ensures that the tool can accommodate various RJ jack designs and configurations, making it suitable for a wide range of applications in both high-density and standard-density termination environments.

The wire termination and cutting tool described is enhanced by several key features: it utilizes a stronger polymer material for increased durability, includes a versatile slider track mechanical mechanism capable of multiple orientations to accommodate various keystone jacks, and is configured including but not limited to a particular slider track design to maintain broad applicability. The tool is adaptable for use with two or more different types of keystone jacks and features a lead wire hole design to facilitate precise wire placement and termination.

The various features of novelty that characterize the invention are pointed out with particularity in the claims annexed to and formed a part of this disclosure. For a better understanding of the invention, its operating advantages, and specific objects attained by its uses, refer to the drawings and descriptive matter in which preferred embodiments of the invention are illustrated.

### BRIEF DESCRIPTION OF THE DRAWINGS

### In the Drawings:

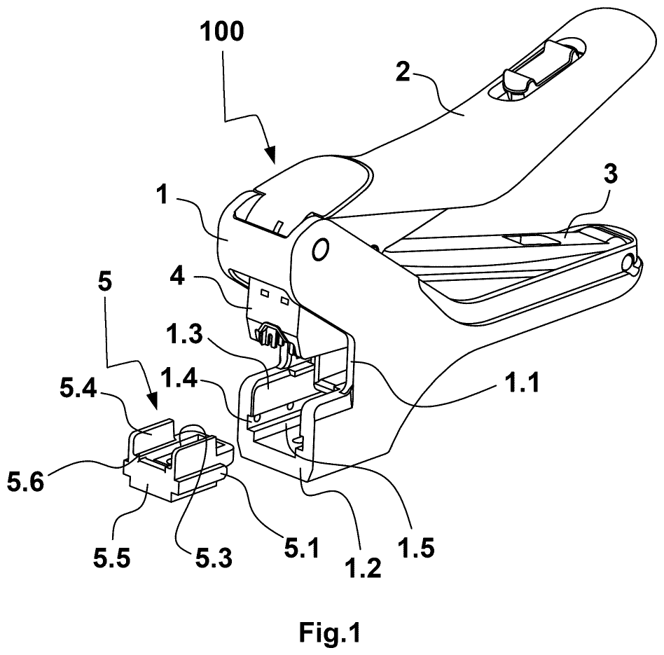

FIG. 1 is a perspective view showing a wire termination and cutting tool according to a first embodiment of the invention with a base slider shown aligned for insertion in an RJ jack support portion 1.2 of a tool base;

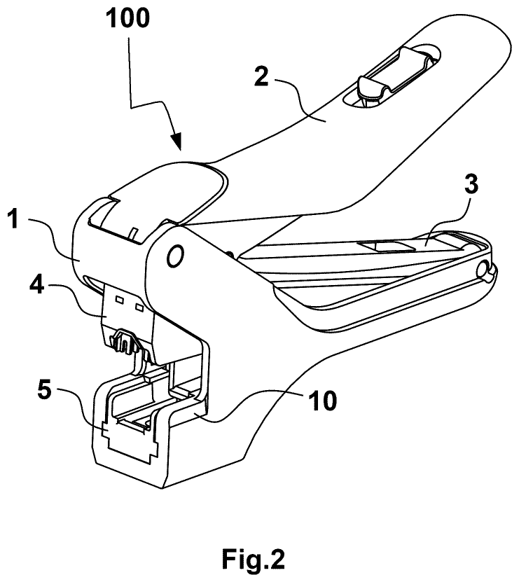

FIG. 2 is a perspective view showing the wire termination and cutting tool with the base slider in a first slider position;

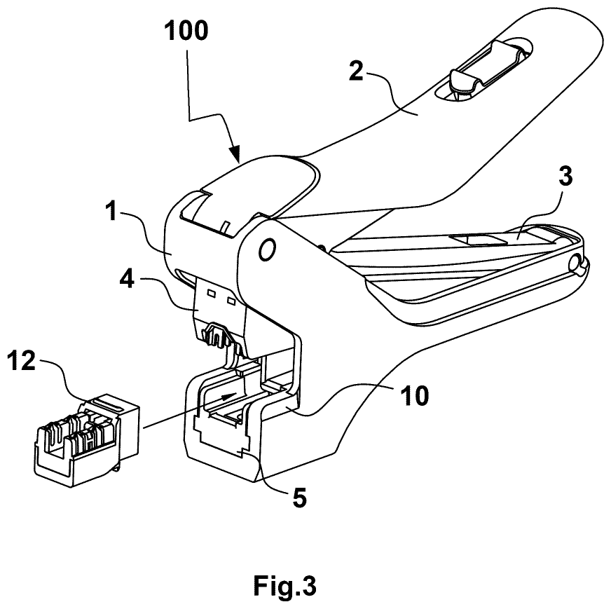

FIG. 3 is a perspective view showing the wire termination and cutting tool and showing an RJ jack of a first orientation type positioned to be inserted into a base slider space;

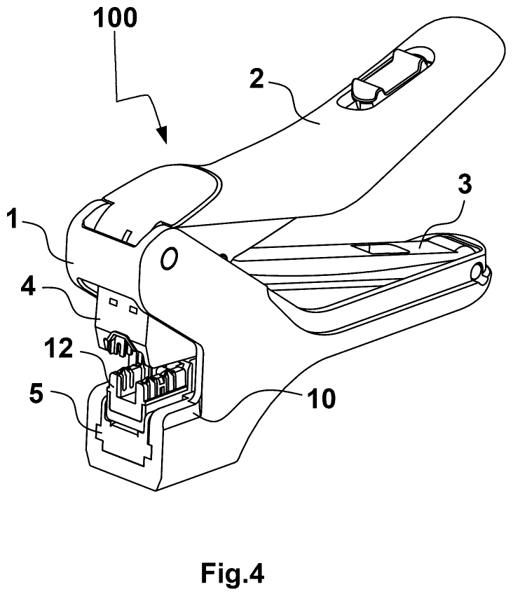

FIG. 4 is a perspective view showing the wire termination and cutting tool with the RJ jack of the first orientation type inserted in the base slider space;

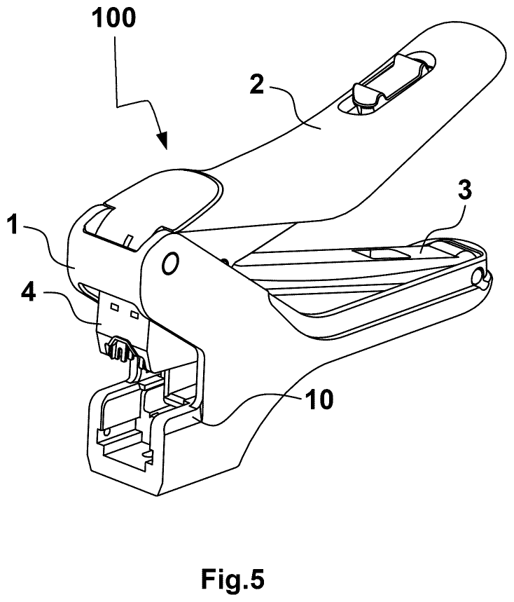

FIG. 5 is a perspective view showing the wire termination and cutting tool with the base slider pushed back to the second slider position;

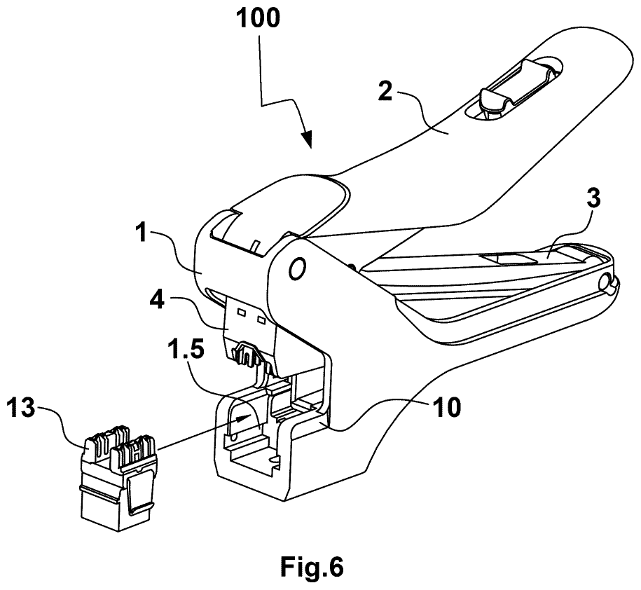

FIG. 6 is a perspective view showing the wire termination and cutting tool and showing an RJ jack of a second orientation type positioned to be inserted into a jack/slider receiving surface space, with the base slider in the second slider position;

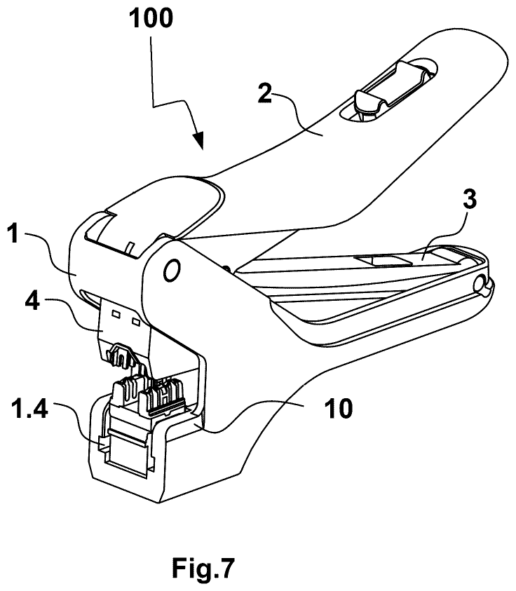

FIG. 7 is a perspective view showing the wire termination and cutting tool with the RJ jack of the second orientation type inserted in the receiving surface space;

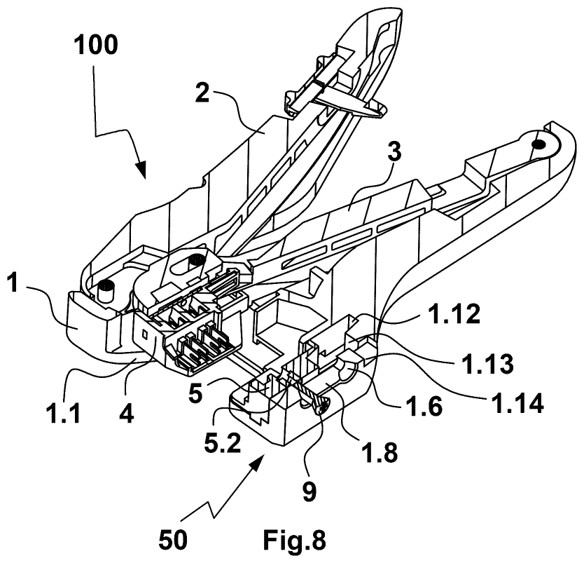

FIG. 8 is a sectional view showing details of a screw slider fixing mechanism that comprises a screw fixing configuration of the wire termination and cutting tool with cooperating with a screw fixed base slider in the first slider position;

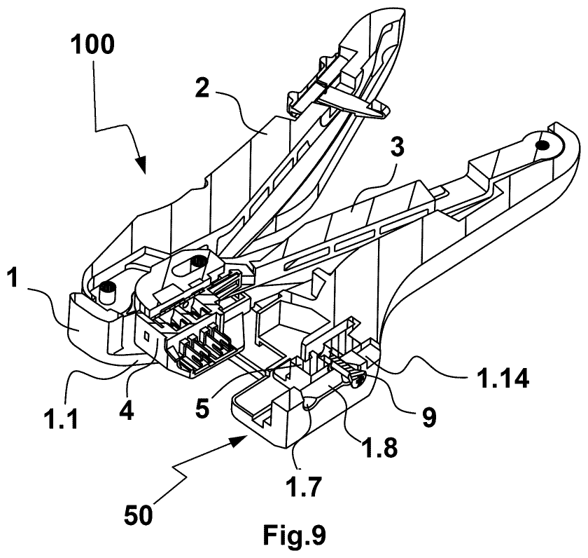

FIG. 9 is a sectional view showing the screw slider fixing mechanism with the screw fixed base slider in the second slider position;

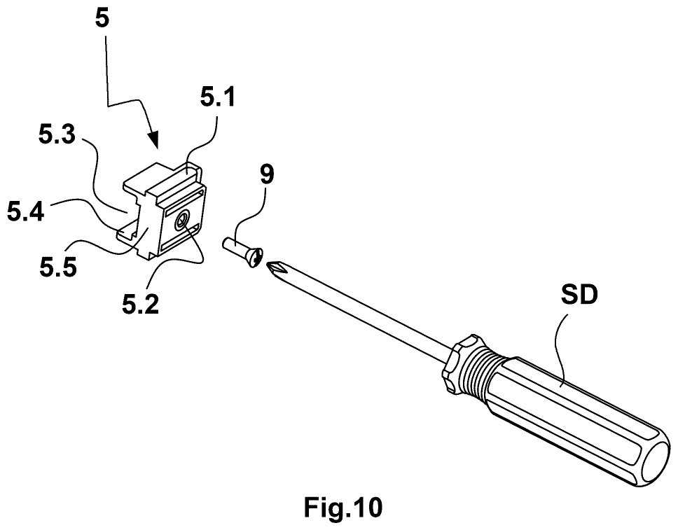

FIG. 10 is a perspective view showing the screw fixed base slider;

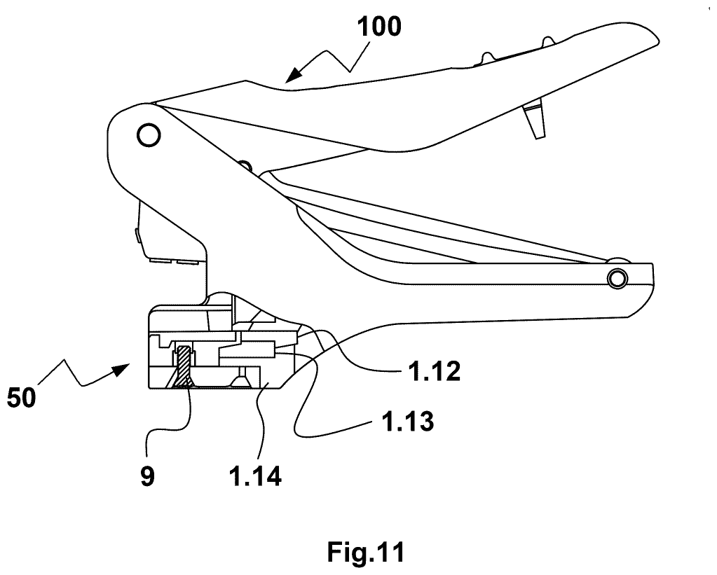

FIG. 11 is a partial sectional view showing the screw slider fixing mechanism with the screw fixed base slider in the first slider position

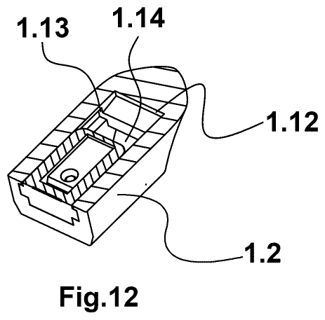

FIG. 12 is a sectional perspective view showing a tool base of the wire termination and cutting tool with a limiting portion surface for delimiting the slider base and showing the screw fixed base slider;

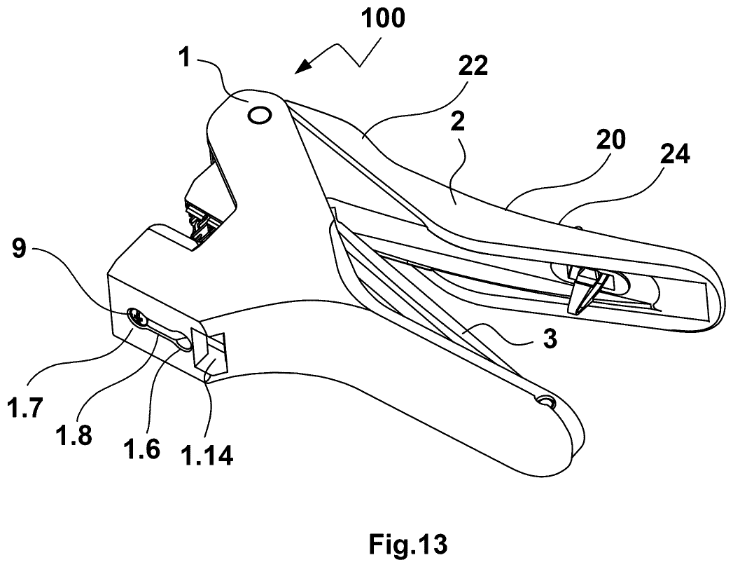

FIG. 13 is a perspective view of the wire termination and cutting tool, highlighting a screw slider track and a wire release mechanism hole;

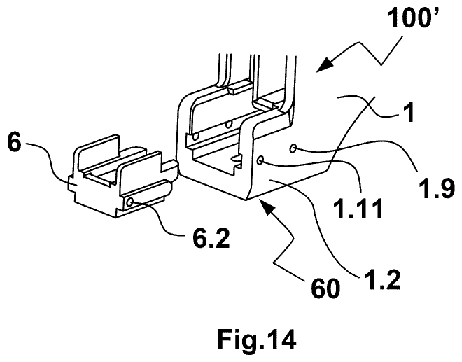

FIG. 14 is a partial perspective view of the wire termination and cutting tool according to another embodiment of the invention with a steel ball slider fixing configuration cooperating with a steel ball fixed slider to provide a steel ball slider fixing mechanism;

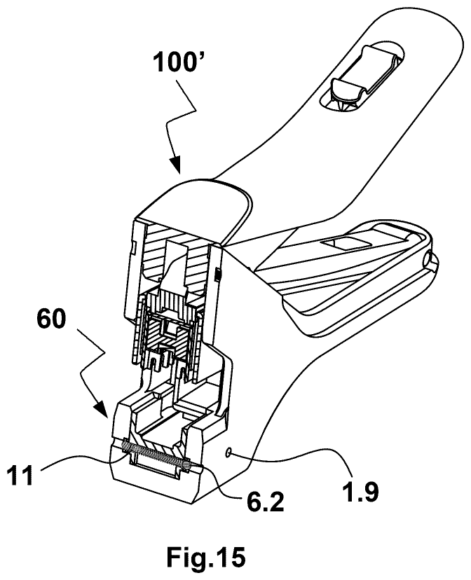

FIG. 15 is a sectional view showing features of the steel ball slider fixing mechanism;

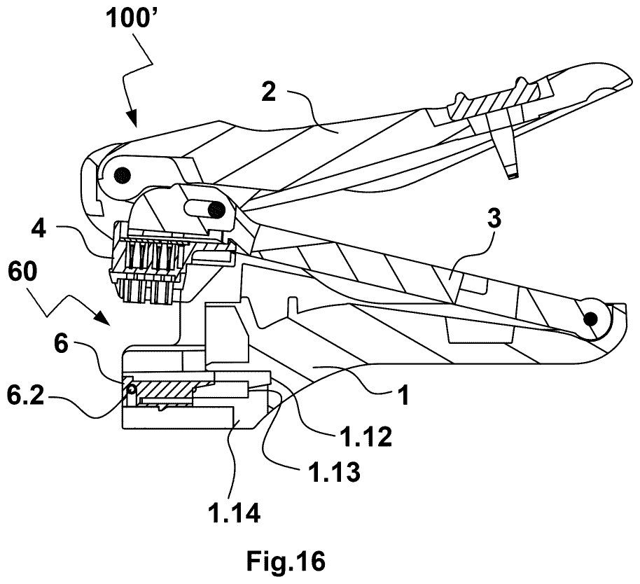

FIG. 16 is a sectional view of the wire termination and cutting tool, showing the first slider position of the steel ball fixed base slider and showing a limiting portion surface;

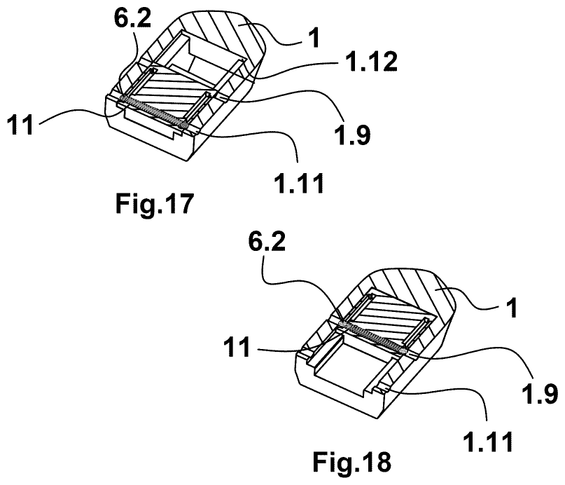

FIG. 17 is a sectional view of the base RJ support portion 1.2 of the tool base and the steel ball fixed base slider in the first fixing position;

FIG. 18 is a sectional view of the base RJ support portion 1.2 of the tool base and the steel ball fixed base slider 6 with the second fixing position;

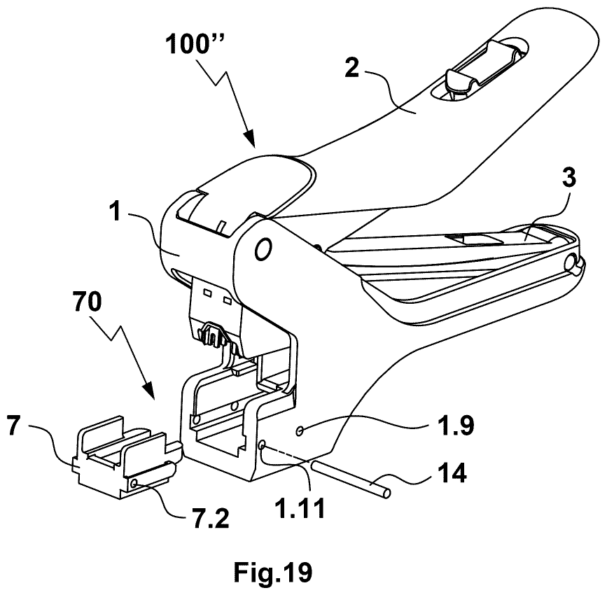

FIG. 19 is a perspective view showing a wire termination and cutting tool according to another embodiment of the invention with pin slider fixing and guiding configuration cooperating with a pin/latch fixed base slider, shown aligned for insertion in the RJ jack support portion, to form a pin slider fixing mechanism;

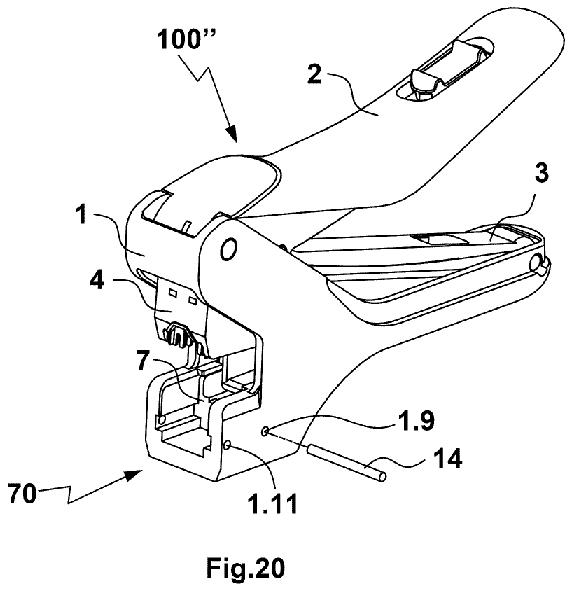

FIG. 20 is a perspective view of the wire termination and cutting tool showing the pin slider fixing mechanism with the pin/latch fixed base slider in the second slider position;

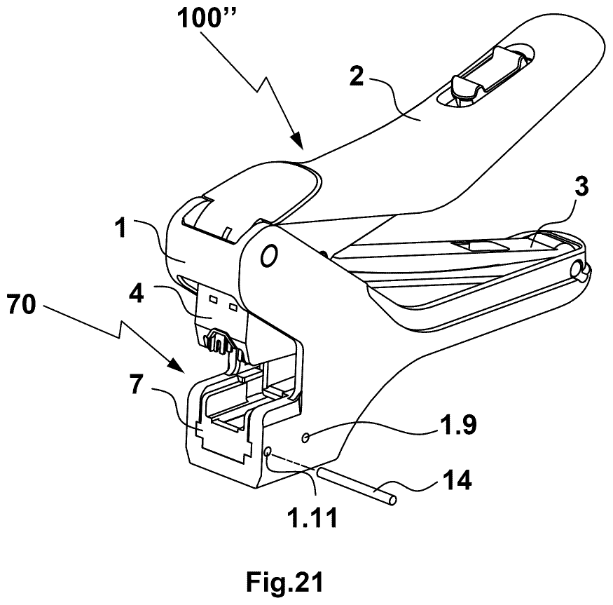

FIG. 21 is a perspective view of the wire termination and cutting tool showing the base slider fixing mechanism with the pin/latch fixed base slider in the first slider position;

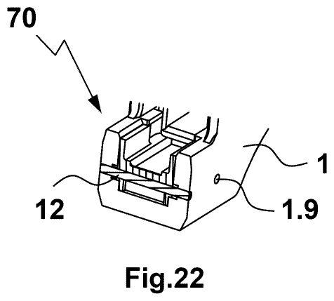

FIG. 22 is a partial sectional view showing the pin/latch fixed base slider and RJ jack support portion of the tool base highlighting the pin slider fixing mechanism;

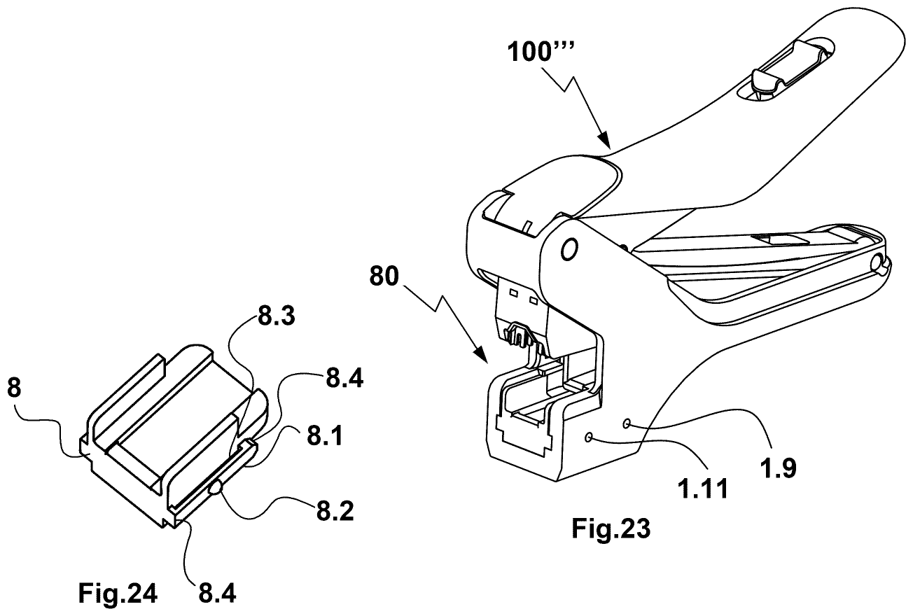

FIG. 23 is a perspective view showing a wire termination and cutting tool according to another embodiment of the invention with a protrusion and guiding fixing configuration with protrusion fixed base slider in the first slider position, which cooperates with the protrusion fixing and guiding configuration to form a protrusion slider fixing mechanism;

FIG. 24 is a perspective view showing the protrusion fixed base slider;

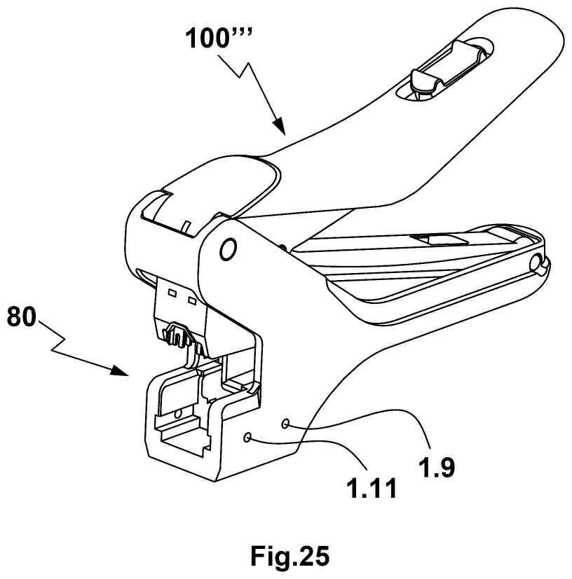

FIG. 25 is a perspective view showing a wire termination and cutting tool of the embodiment of FIG. 8, with the protrusion fixed base slider in the second slider position;

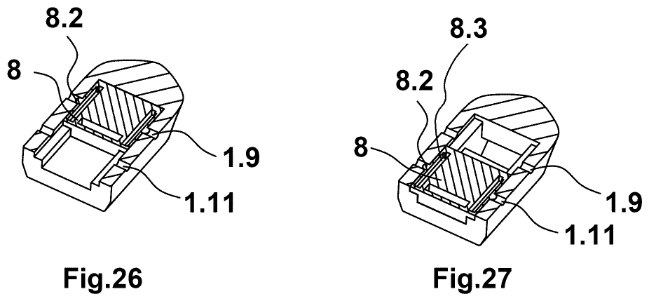

FIG. 26 is a sectional view of the RJ jack support portion with protrusion fixed base slider in the second fixing position;

FIG. 27 is a sectional view of the RJ jack support portion with the protrusion fixed base slider in the first fixing position;

### DETAILED DESCRIPTION

Referring to the drawings, a wire termination and cutting tool 100 (FIGS. 1-13) is configured for RJ jacks with a plurality of orientations for various RJ jacks. The wire termination and cutting tool 100 comprises a tool base 1 with a tool cutting module support portion 1.1 that supports a cutting module (tool blade assembly) 4. The tool base 1 includes an RJ jack support portion 1.2. The tool base 1 is connected to a tool handle 2 and lever 3 for relative movement of the cutting module 4 relative to the RJ jack support portion 1.2. This is achieved with the tool handle 2 and the lever 3 for applying force to move the cutting module 4 with respect to the RJ jack support portion 1.2 for terminating and cutting wires relative to a positioned RJ jack 12, 13. The wire termination and cutting tools 100′ (FIG. 14-18), 100″ (FIG. 19-22) 100″′ (FIG. 23-27) of other embodiments of the invention have similar features.

The RJ jack support portion 1.2 includes a guiding configuration with a tool base receiving surface 1.3, slider track 1.4, and tool based stopping surface 1.12 and slider track stopping surface 1.13 that at least partially delimit a jack/slider receiving space 1.5. Base sliders 5, 6, 7, and 8 are configured to contact both the tool base receiving surface 1.3 and the slider track 1.4. The base slider is moveable along the slider track 1.4 between a first slider position (FIGS. 2, 3, 4, 8, 11, 12, 13, 15, 16, 17, 21, 22, 23, and 25), relative to the slider track 1.4, and a second slider position (FIGS. 5, 6, 7, 9, 18, 20, 25, and 26), relative to the slider track 1.4. The different examples of the base sliders 5, 6, 7, and 8 include slider surface features that define a jack receiving space 5.3 for both receiving an RJ jack 12 having a first orientation (90 degrees wire termination direction relative to plug insertion direction) and RJ jack 13 having a second orientation (180 degrees wire termination direction relative to plug insertion direction). The RJ jack 12 having the first orientation is receivable in the jack/slider receiving space 1.5 to position the RJ jack 12 relative to the cutting module 4 with the base sliders 5, 6, 7, and 8 in the first slider position (FIG. 4). Having the second orientation, the RJ jack 13 is receivable in the jack/slider receiving space 1.5 to position the RJ jack 13 relative to the cutting module 4 with the base sliders 5, 6, 7, and 8 in the second slider position (FIG. 6). With use and operation of wire termination and cutting tool 100, 100′, 100″, 100′″, this single tool can complete the cutting and punching of two or more different types of RJ45 jacks. With the base sliders 5, 6, 7, and 8 in the first slider position, jack receiving space 5.3 is between the cutting module 4 and the base sliders 5, 6, 7, and 8, allowing the insertion of the first RJ-type jacks 12 (90-degree RJ45 jack), after which the cutting and punching operations can be performed. With the base sliders 5, 6, 7, and 8 pushed (FIG. 5) into the second fixed position, the jack/slider receiving space 1.5 is between the cutting module 4 and the jack receiving space 5.3 allowing the insertion of the RJ-type jacks 13 (180-degree RJ45 jack) for cutting and punching operations.

The wire termination and cutting tools 100, 100′, 100″, 100′″, 100′, 100″, 100′″ further each include a fixing configuration that cooperates with the base slider 5, 6, 7, or 8 to form a slider fixing mechanism 50, 60, 70 or 80. The fixing and guiding configuration of the cutting tool 100, 100′, 100″, 100′″ cooperates with the slider fixing mechanism 50, 60, 70 or 80 to fix the base sliders 5, 6, 7,or 8 in two or more of the slider positions, such as the first slider position and the second slider position. Several embodiments of the example wire termination and cutting tool 100, 100′, 100″, 100′″ are disclosed herein. Each has a different fixing configuration cooperating with different base sliders 5, 6, 7, or 8 to provide the fixing mechanism 50, 60, 70 or 80.

As can be seen in FIGS. 1, 14, 19, and 23, each of the base sliders 5, 6, 7, and 8 has a cooperating guide feature with a fixed base slider shoulder (rail) 5.1 (configured for slider track 1.4) and a slider base portion 5.5, and provides a jack receiving space 5.3. The jack receiving space 5.3 is delimited by an inner wall 5.4, and an upper surface 5.6 of slider base portion 5.5.

### Screw Slider Fixing Mechanism

According to an embodiment, a screw slider fixing mechanism 50 is comprised of a fixing configuration of the wire termination and cutting tools 100 and features of the base slider 5 (see particularly FIG. 8-13). The screw slider fixing mechanism 50 includes fixing openings 1.6 and 1.7 in the jack support portion 1.2 of the tool base 1. The fixing openings comprise the first fixing opening 1.7 to establish the first slider position relative to the receiving surface 1.3 and the second fixing opening 1.6 to establish the second slider position relative to the receiving surface 1.3. The base slider 5 has a slider fixing opening 5.2 (FIG. 10). The base slider fixing opening 5.2 is configured to be in registration with the first fixing opening 1.7 with the base slider 5 in the first slider position and to be in registration with the second fixing opening 1.6 with the base slider 5 in the second slider position 32. A fixing member in the form of a screw 9 is insertable in the first fixing opening .17 and the base slider fixing opening 5.2 to fix the base slider 5 in the first slider position (FIG. 8) and is insertable in the second fixing opening 1.6 and the base slider fixing opening 5.2 to fix the base slider 5 in the second slider position (FIG. 9).

There is a cooperation of the slider track 1.4 and the base slider shoulder 5.1, the screw 9, the second limit hole 1.6 of the base 1, a screw slide track 1.8 of the base 1, and the first limit hole 1.7 of base 1. These features work together to achieve the function of a limited adjustment mechanism or limited adjustable fixing mechanism. By adjusting a depth of tightening/insertion of the screw 9 (FIGS. 8 and 9), and moving the base slider 5 with the screw 9 moving along the screw slide track 1.8 of the base 1, the screw can slide between and to the second limit hole 1.6 of base 1 and the first limit hole 1.7 of base 1 to achieve the adjustment of the position of the base slider 5. As shown in FIGS. 8 and 9, with a sliding of the base slider 5 along the base slider track 1.4, the screw 9 may be locked into the corresponding screw fixing hole 5.2, fixing the position of the base slider 5. By adjusting screw 9 (FIGS. 8 and 9) with a screwdriver SD, the slider 5 is fixed in one of the slider positions.

### Steel Ball Slider Fixing Mechanism

According to another embodiment a steel ball slider fixing mechanism 60 is comprised of a fixing configuration of the wire termination and cutting tools 100′ and features of the base slider 6 (FIG. 14-18). The steel ball slider fixing mechanism 60 comprises fixing portions in the RJ jack support portion 1.2 of the tool base 1. The fixing portions may comprise a first recess or hole at the second fixed position hole/cavity/fixed point 1.9 and the first fixed position hole/cavity/fixed point 1.11 to establish the first slider position and the second slider position with jack/slider receiving space 1.5 and jack receiving space 5.3. A steel ball 6.2 is associated with the steel ball fixed base slider 6 and cooperates with the pathway of slider track 1.4 and the first recesses or holes 1.9 and 1.11 to provide a protrusion mechanism.

The fixing member of the steel ball slider fixing mechanism 60 comprises the steel ball 6.2, which is biased by a fixing spring 11 that is supported in a fixing channel of the steel ball base slider 6. The steel ball base slider 6 carries the assembly including the positioning steel ball 6.2 positioned on one or both sides and the spring 11 working together. The spring 11 provides continuous spring force pressure to the positioning steel ball 6.2, making the positioning steel ball an elastic protrusion within the mechanism (an elastic, biased fixing element). The steel ball 6.2 is adjusted and positioned at the second fixed position hole/cavity/fixed point 1.9 and the first fixed position hole/cavity/fixed point 1.11 to create two different orientations to fit the first RJ45 jack −90 degrees 12 and the second RJ45 jack −180 degrees 13. This works in conjunction with the second fixed position hole/cavity/fixed point 1.9 and the first fixed position hole/cavity/fixed point 1.11 of the tool base 1 to achieve the tool adjustment function.

As the positioning steel ball 6.2 is spring loaded with the spring 11 toward the engagement position, it is possible to move the base slider with a force such that the positioning steel ball 6.2 moves out of the engagement position, and out of engagement along the fixed base slider shoulder 5.1, allowing the base slider to move to the other position and have the positioning ball engage the other of the openings. The steel ball fixed base slider 6 is delimited in movement by the second fixed position hole/cavity/fixed point to achieve the first slider position. The steel ball fixed base slider 6 is further delimited in movement by the tool based stopping surface 1.12 and slider track stopping surface 1.13 for the second slider position.

### Pin Slider Fixing Mechanism

According to another embodiment, a pin base slider fixing mechanism 70 is comprised of a fixing configuration of the wire termination and cutting tools 100″ and features of the base slider 7 (FIGS. 19-22). The pin base slider fixing mechanism includes the second fixed position hole/cavity/fixed point 1.9 and the first fixed position hole/cavity/fixed point 1.11 in the RJ jack support portion 1.2 of the tool base 1. The pin/latch fixed base slider 7 includes a pin/latch hole 7.2 assembled with a fixing pin 14 in the second fixed position hole/cavity/fixed point 1.9 and the first fixed position hole/cavity/fixed point 1.11 to establish the first slider position and the second slider position. The fixing member in the form of the fixing pin 14 is insertable in the fixing Pin/latch hole 7.2, the first fixing position hole/fixed point 1.9, and the first fixed position hole/cavity/fixed point 1.11.

There is a cooperation of the base slider track 1.4, pin/latch fixed base slider 7, and the fixed base slider shoulder rail 5.1 to achieve the slider fixing mechanism, the fixing pin 14, second fixed position hole/cavity/fixed point 1.9, and the first fixed position hole/cavity/fixed point 1.11. The relative position of the pin/latch fixed base slider 7 is adjusted in different fixed holes (1.9 and 1.11 in this case). These features work together to achieve the function of a limited adjustment mechanism or limited adjustable fixing mechanism.

The pin/latch fixed base slider 7 is positioned (or temporarily fixed/fixed) by the second fixed position hole/cavity/fixed point to achieve the first slider position, where the fixing pin 14 is inserted through the second fixed position hole/cavity/fixed point 1.9 and pin/latch hole 7.2. The pin/latch fixed base slider 7 is positioned (or temporarily fixed/fixed) by the first fixed position hole/cavity/fixed point to achieve the second slider position, where the fixing pin 14 is inserted through the first fixed position hole/cavity/fixed point 1.11 and pin/latch hole 7.2. The pin/latch fixed base slider 7 is further limited in movement by the tool based stopping surface 1.12 and slider track stopping surface 1.13, that stop movement beyond the second slider position.

### Protrusion Slider Fixing Mechanism

According to another embodiment, a protrusion slider fixing mechanism 80 is comprised of a fixing configuration of the wire termination and cutting tools 100′″ and features of the base slider 8 (FIGS. 23-27) with fixing portions in the RJ jack support portion 1.2 of the tool base 1. The fixing portions may comprise a first recess or second fixed position hole/cavity/fixed point 1.9 and the first fixed position hole/cavity/fixed point 1.11 to establish the first slider position and second slider position to create jack/slider receiving space 1.5 and jack receiving space 5.3.

The protrusion slider fixing mechanism 80 comprises a protrusion support, comprised of spaced apart attachment portions 8.4 and slider bridge portion 8.1, associated with the protrusion fixed base slider 8 and an elastic protrusion 8.2 elastically supported by the protrusion support 8.1, 8.4 and biased towards the engagement position. The elastic protrusion 8.2 is engageable with the first recess first/fixed position hole/fixed point 1.9 to fix the fixed base slider 8 in the first slider position allowing the jack/slider receiving surface space to receive first RJ45 jack −90-degree 12. The elastic protrusion 8.2 is engageable with the second recess/first fixed position hole/cavity/fixed point 1.11 to fix the fixed base slider 8 in the second slider position allowing the jack/slider receiving surface space to receive first RJ45 jack −180-degree 13.

The protrusion fixed base slider 8 is comprised of the elastic protrusion 8.2 positioned (both sides) working together. Due to the configuration and the material properties of the protrusion fixed base slider 8 and the elastic protrusion 8.2 can move, with slider bridge being compressed or deformed temporarily relative to space an elastic deformation space 8.3, to achieve the protrusion slider fixing mechanism 80. The protrusion acts as an elastic protrusion mechanism, working in conjunction with the second fixed position hole/cavity/fixed point 1.9 and first fixed position hole/cavity/fixed point 1.11 to achieve the tool adjustment function.

There is a cooperation of the base slider track 1.4, protrusion fixed base slider 8, and the base slider shoulder rail 5.1 to achieve the slider fixing mechanism, elastic protrusion 8.2, second fixed position hole/cavity/fixed point 1.9, and the first fixed position hole/cavity/fixed point 1.11. The elastic protrusion can move along the slider track 1.4 with its contraction mechanical property to position the protrusion 8.2 in different holes or recesses. The elastic protrusion 8.2 positioned (or temporarily fixed/fixed) by the second fixed position hole/cavity/fixed point 1.11. to achieve the first slider position, where elastic protrusion 8.2 is locked in place in second fixed position hole/cavity/fixed point 1.9. The elastic protrusion 8.2 positioned (or temporarily fixed/fixed) by the second fixed position hole/cavity/fixed point to achieve the first slider position, where elastic protrusion 8.2 is locked in place in the first fixed position hole/cavity/fixed point 1.11 to achieve the second slider position. The movement of the protrusion fixed base slider 8 is further delimited by the tool based stopping surface 1.12 and slider track stopping surface 1.13 for the second slider position. These features work together to achieve the function of a limited adjustment mechanism or limited adjustable fixing mechanism. The concave-convex design of the protrusion is interchangeable; for example, the convex design of the first fixed position hole and second fixed position hole 1.9 and 1.11 can be replaced with a concave configuration and the limiting part protrusion 8.2 can be an elastic convex protrusion.

### Wire Release Mechanism

For each embodiment, a wire release hole 1.14 and the wire release mechanism-configuration for wire release after cutting the RJ jack support portion 1.2 may form a wire release mechanism 10 (FIG. 2). The wire release mechanism 10 is configured for wire release after cutting and terminating wires with the cutting module 4. This ensures that wires are properly terminated and any excess wire is efficiently removed, allowing for a clean and precise connection.

A wire termination and cutting tool 100, 100′, 100″, 100′″ may be formed of metal, but advantageously the cutting tool (100, 100′, 100″, 100′″) is at least partially formed of a high-strength polymer. This significantly reduces the weight of the tool while maintaining structural integrity and durability. This polymer material—high-strength polymer—improves user ergonomics and handling during the termination processes. Preferably, at least the tool cutting module supports portion 1.1, and the rest of the tool base 1 is at least partially formed of plastic.

The handle 2, connected to the base 1 and the tool cutting module 4, comprises an ergonomic shape 20 configured to reduce user fatigue, namely the ergonomic shape reduces the strain on the user's hand and wrist during repetitive use, minimizing fatigue and the risk of repetitive strain injuries. The handle is configured with a comfort contoured grip 22, contoured to fit comfortably in the user's hand. The comfort contoured grip 22 may have features such as a padded grip 24 and an angled design that allows for natural wrist positioning. The contoured grip 22 is padded with soft, non-slip materials 24 at contact points, distributing weight evenly to reduce operational effort, minimizing pressure points to prevent discomfort and fatigue, enabling prolonged use with reduced risk of repetitive strain injuries.

The RJ jacks have a plurality of orientations, comprising standard RJ jacks and high-density RJ jacks. The wire termination and cutting tools 100, 100′, 100″, 100′″ are compatible with, including but not limited to, standard RJ jacks and high-density RJ jacks. FIGS. 2 and 3 show the first RJ45 jack 12 (90 degrees wire termination direction relative to plug insertion direction), and FIGS. 6 and 7 show a second RJ45 jack type 13 (180 degrees wire termination direction relative to plug insertion direction). Both jacks 12 and 13 can be either standard RJ jacks or high-density RJ jacks, depending on the specific application and design requirements.

A mechanism for cutting excess wire length shown in FIG. 7 that includes wire release mechanism 10 and as shown in FIG. 13, a wire release hole 1.14. The wire termination typically consists of a cutting blade integrated into the tool. Once the wires are inserted and terminated in the jack, any protruding wire ends are cut off by blade assembly 4 and are released with wire release mechanism 10 and wire release hole 1.14. This mechanism ensures that no excess wire remains, which could interfere with the connection or cause shorts. The cutting action is usually triggered automatically as part of the termination process, ensuring a clean and efficient cut.

While specific embodiments of the invention have been shown and described in detail to illustrate the application of the principles of the invention, it will be understood that the invention may be embodied otherwise without departing from such principles.

### LIST OF REFERENCE NUMBERS

1. Tool base—tool holder—tool mount
1.1 Tool cutting module support portion
1.2 RJ jack support portion
1.3 Tool Base Receiving surface
1.4 Slider Track
1.5 Jack/slider receiving surface space
1.6 Second screw hole
1.7 first screw hole
1.8 Screw used Slider Track
1.9 Second fixed position hole/cavity/fixed point
1.11 First fixed position hole/cavity/fixed point
1.12 Tool Based Stopping Surface
1.13 Slider Track Stopping Surface
1.14 Wire Release Hole
2. Tool handle—tool actuator handle for applying force to move the with respect to the RJ jack support portion
3. Lever
4. Blade assembly (tool cutting module—connected to the cutting module support portion of tool base)
5. Screw fixed base slider
5.1 Fixed base slider shoulder (rail)
5.2 Screw fixing hole (slider fixing opening)
5.3 Jack receiving space (n/o 1, 10) (Slider space)
5.4 Jack receiving space Inner wall
5.5. Slider base portion front surface
5.6 Upper surface of slider base portion
6. Steel ball fixed base slider
6.2 Steel ball
7. pin/latch fixed base slider
7.2 Pin/latch hole
8 Protrusion fixed base slider
8.1 Protrusion fixed base slider bridge portion
8.2 Elastic Protrusion
8.3 Elastic deformation (contraction) space
8.4 Spaced apart attachment portions
9 Fixing Screw (fixing Member)
10 Wire release mechanism—configuration for wire release after cutting
11 Spring
12. First RJ45 jack—90-degree
13. Second RJ45 jack type—180-degree
14 Fixing pin (fixing member)
20 Ergonomic handle grip (curved surface)
22 Comfort contour
24 Padded grip
50 Screw slider fixing mechanism
60 Steel ball slider fixing mechanism
70 Limit stop/pin slider fixing mechanism
80 Protrusion slider fixing mechanism
100, 100′, 100″, 100′″ Wire termination and cutting tool
SD Screw driver

What is claimed is:

1. A wire termination and cutting tool for RJ jacks having a plurality of orientations, the wire termination and cutting tool comprising:
a tool base comprising a tool cutting module support portion and an RJ jack support portion comprising a jack or slider receiving surface;
a cutting module connected to the cutting module support portion, the tool base being configured with the cutting module support portion for movement of the cutting module relative to the RJ jack support portion;
a tool handle for applying force to move the cutting module with respect to the RJ jack support portion;
a base slider configured to be positioned in contact with the receiving surface and moveable along the receiving surface between a first slider position relative to the receiving surface and a second slider position or more positions relative to the receiving surface, wherein the base slider defines a slider space for receiving an RJ jack having a first orientation and cooperates with the receiving surface to define a receiving surface space for receiving an RJ jack having a second orientation, wherein the RJ jack having the first orientation is receivable in the base slider space to position the RJ jack having the first orientation relative to the cutting module with the base slider in the first slider position and the RJ jack having the second orientation is receivable in the receiving surface space to position the RJ jack having the second orientation relative to the cutting module with the base slider in the second slider position; and
a slider fixing mechanism to fix the base slider in one or more of the first slider position and the second slider position.

2. A wire termination and cutting tool according to claim 1,
wherein the base slider comprises a slider base portion with slider side walls extending therefrom,
wherein the base slider space is delimited by an inner surface of the base slider side walls and an upper surface of the base slider base portion; and
wherein the receiving surface space is delimited by support portion side walls and a support portion base wall that define the receiving surface and by a front surface of the base slider, with the base slider in the second slider position.

3. A wire termination and cutting tool according to claim 1, wherein the base slider and the receiving surface cooperate to form a slider guide to guide the movement of the base slider between the first slider position and the second slider position.

4. A wire termination and cutting tool according to claim 1, wherein the base slider and the receiving surface cooperate to form a slider limit stop to limit the movement of the base slider beyond at least one of the first slider position and the second slider position.

5. A wire termination and cutting tool according to claim 1, wherein the slider fixing mechanism comprises:
fixing openings in the jack support portion, the fixing openings comprising a first fixing opening to establish the first slider position relative to the receiving surface and a second fixing opening to establish a second slider position relative to the receiving surface;
a base slider fixing opening, wherein the base slider fixing opening is configured to be in registration with the first fixing opening, with the base slider in the first slider position relative to the receiving surface, and to be in registration with the second fixing opening, with the base slider in the second slider position relative to the receiving surface; and
a fixing member insertable in the first fixing opening and the base slider fixing opening to fix the base slider in the first slider position relative to the receiving surface and insertable in the second fixing opening and the base slider fixing opening to fix the base slider in the second slider position relative to the receiving surface.

6. A wire termination and cutting tool according to claim 5, wherein the fixing member comprises a screw or a pin.

7. A wire termination and cutting tool according to claim 1, wherein the slider fixing mechanism comprises:
fixing portions in the jack support portion, the fixing portions comprising a first recess or hole to establish the first slider position relative to the receiving surface and a second recess or hole to establish a second slider position relative to the receiving surface; and
a fixing member associated with the base slider and resiliently supported at the base slider and biased towards an engagement position, wherein with the fixing member in the engagement position, the fixing member is received in the first recess or hole to fix the base slider in the first slider position relative to the receiving surface and with the fixing member in the engagement position the fixing member is received in the second recess or hole to fix the base slider in the second slider position relative to the receiving surface.

8. A wire termination and cutting tool according to claim 7, wherein the fixing member comprises:
a fixing channel or bore;
a fixing spring supported in the fixing channel or bore; and
a positioning ball supported relative to the channel or bore and biased towards the engagement position, whereby the positioning ball is engageable with the first recess or hole to fix the base slider in the first slider position relative to the receiving surface and the positioning ball is engageable with the second recess or hole to fix the base slider in the second slider position relative to the receiving surface.

9. A wire termination and cutting tool according to claim 7, wherein the fixing member comprises:
a protrusion support associated with the base slider; and
a protrusion elastically supported by the protrusion support relative to the base slider and biased towards the engagement position, whereby the protrusion is engageable with the first recess or hole to fix the base slider in the first slider position relative to the receiving surface and the protrusion is engageable with the second recess or hole to fix the base slider in the second slider position relative to the receiving surface.

10. A wire termination and cutting tool according to claim 9, wherein the protrusion support comprises:
spaced apart attachment portions attached to the base slider; and
a bridging portion supporting the protrusion, the bridging portion extending between the spaced apart attachment portions to define an elastic contraction space to allow elastic flexing of the bridging portion to allow movement of the protrusion out of the first recess or hole and out of the second recess or hole.

11. A wire termination and cutting tool according to claim 1, wherein the support portion side walls form a wire release mechanism configured for wire release after a cutting of wires being cut and terminated with the cutting module.

12. A wire termination and cutting tool according to claim 1, wherein the tool cutting module support portion and the tool base are at least partially formed of polymer.

13. The wire termination and cutting tool according to claim 1, further comprises an alignment guide configured for precise wire placement to ensure accurate and consistent positioning during termination, comprising multiple channels or slots corresponding to required positions for proper wire termination, maintaining correct spacing and orientation upon wires being inserted.

14. The wire termination and cutting tool according to claim 1, wherein the tool handle, connected to the tool cutting module support portion, comprises an ergonomic shape configured to reduce user fatigue, comfortably fitting within the user's hand to reduce strain during extended use, with a contoured grip conforming to the natural curve of the hand for a secure hold.

15. The wire termination and cutting tool according to claim 14, wherein the contoured grip is padded with soft, non-slip materials at contact points, distributing weight evenly to reduce operational effort, minimizing pressure points to prevent discomfort and fatigue, enabling prolonged use with reduced risk of repetitive strain injuries.

16. The wire termination and cutting tool according to claim 1, wherein the RJ jacks have a plurality of orientations comprise standard RJ jacks and high-density RJ jacks, wherein the wire termination and cutting tool is compatible with both standard RJ jacks and high-density RJ jacks.

17. The termination tool of claim 1, further comprises a cutting mechanism for trimming excess wire length following wire termination, with the cutting mechanism integrated into the tool and operable by squeezing the handle or engaging a lever, causing high-strength blades to sever the excess wire coordinated to the termination point, thereby ensuring termination.
